(19) United States
(12) Patent Application Publication
(10) Pub. No.: US 2026/0004451 A1
(43) Pub. Date: Jan. 1, 2026

(54) GAZE ESTIMATION METHOD AND APPARATUS, READABLE STORAGE MEDIUM, AND ELECTRONIC DEVICE

(71) Applicant: Nanchang Virtual Reality Research Institute Co., Ltd., Nanchang (CN)

(72) Inventor: Hao Xu, Nanchang (CN)

(21) Appl. No.: 19/318,482

(22) Filed: Sep. 4, 2025

Related U.S. Application Data
(63) Continuation-in-part of application No. PCT/CN2023/140005, filed on Dec. 19, 2023.

(30) Foreign Application Priority Data
Feb. 16, 2023 (CN) 202310120571.8

(51) Int. Cl. G06T 7/73; G06V 10/82; G06V 40/18

(52) U.S. Cl. CPC G06T 7/73; G06V 10/82; G06V 40/193; G06T 2207/20081; G06T 2207/20084; G06T 2207/30201

(57) ABSTRACT

The present invention provides a gaze estimation method and apparatus, a readable storage medium, and an electronic device. The method includes: acquiring eye data and determining state and position information of multiple gaze feature points based on the eye data; using each of the gaze feature points as a node, establishing a relationship between the nodes to obtain a graph model; determining feature information of the graph model based on the state and position information of each of the gaze feature points, and assigning the feature information to the graph model to obtain a graph representation corresponding to the eye data; and inputting the graph representation into a graph machine learning model, performing gaze estimation through the graph machine learning model, and outputting gaze data.

### CROSS REFERENCE TO RELATED APPLICATIONS

This application is a Continuation-In-Part Application of PCT Application No. PCT/CN2023/140005 filed on Dec. 19, 2023, which claims priority to Chinese Patent Application No. 202310120571.8, filed on Feb. 16, 2023 and entitled “GAZE ESTIMATION METHOD AND APPARATUS, READABLE STORAGE MEDIUM, AND ELECTRONIC DEVICE”, which is incorporated herein by reference in its entirety.

### TECHNICAL FIELD

The present invention relates to the field of computer vision, and in particular, to a gaze estimation method and apparatus, a readable storage medium, and an electronic device.

### BACKGROUND

Gaze estimation technology is widely applied in fields such as human-computer interaction, virtual reality, augmented reality, and medical analysis. Gaze tracking technology is used to estimate a gaze direction of a user. Typically, gaze estimation for a user is implemented by a gaze estimation apparatus.

Existing gaze estimation methods usually include a gaze calibration process before providing gaze estimation capabilities, which affects user experience. Additionally, during use, it is generally required that the relative pose between the gaze estimation apparatus and the user's head remains fixed. However, it is difficult for users to maintain a fixed relative pose between the gaze estimation apparatus and their head for extended periods, making it challenging to provide accurate gaze estimation capabilities.

### SUMMARY

In view of the above issues, it is necessary to provide a gaze estimation method and apparatus, a readable storage medium, and an electronic device to address the problem of inaccurate gaze estimation in the prior art.

The present invention discloses a gaze estimation method, including:
acquiring eye data and determining state and position information of multiple gaze feature points based on the eye data, where the gaze feature point is a point containing eyeball movement information and usable for calculating gaze data;
using each of the gaze feature points as a node and establishing a relationship between the nodes to obtain a graph model;
determining feature information of the graph model based on the state and position information of each of the gaze feature points, and assigning the feature information to the graph model to obtain a graph representation corresponding to the eye data; and
inputting the graph representation into a graph machine learning model, performing gaze estimation through the graph machine learning model, and outputting gaze data, where the graph machine learning model has been pre-trained using a sample set, and the sample set includes multiple graph representation samples and corresponding gaze data samples.

Further, in the above gaze estimation method, the eye data is an eye image captured by a camera or data collected by a sensor device; where
when the eye data is an eye image captured by a camera, the multiple gaze feature points include at least two essential feature points, or at least one essential feature point and at least one non-essential feature point, where the essential feature point includes a pupil center point, a pupil ellipse focus, a pupil contour point, a feature on the iris, and an iris edge contour point, and the non-essential feature point includes a glint center point and an eyelid key point; and
when the eye data is data collected by a sensor device, the sensor device includes multiple spatially distributed sparse photoelectric sensors, and the multiple gaze feature points are preset reference points of the photoelectric sensors.

Further, in the above gaze estimation method, the eye data is an eye image captured by a camera, and the multiple gaze feature points are multiple feature points determined by performing feature extraction on the eye image through a feature extraction network.

Further, in the above gaze estimation method, the feature information includes a node feature and/or an edge feature, where the node feature includes:
a state and/or a position of a gaze feature point corresponding to a node; and
the edge feature includes:
a distance and/or a vector between gaze feature points corresponding to two nodes connected by an edge.

Further, in the above gaze estimation method, the step of establishing a relationship between the nodes includes:
connecting the nodes with edges according to a preset rule based on a distribution pattern of the nodes.

Further, in the above gaze estimation method, the eye data is an eye image captured by a camera, the multiple gaze feature points include a pupil center point and multiple glint center points around the pupil center point, and the step of connecting the nodes with edges according to a preset rule based on a distribution pattern of the nodes includes:
connecting a node corresponding to the pupil center point with nodes corresponding to the glint center points using undirected edges.

Further, in the above gaze estimation method, the eye data is an eye image captured by a camera, the multiple gaze feature points are feature points determined by performing feature extraction on the eye image through a feature extraction network, and the step of connecting the nodes with edges according to a preset rule based on a distribution pattern of the nodes includes:
connecting adjacent feature points with an undirected edge.

Further, in the above gaze estimation method, the eye data is data collected by a sensor device, the sensor device includes multiple spatially distributed sparse photoelectric sensors, the multiple gaze feature points are preset reference points of the photoelectric sensors, and the step of connecting the nodes with edges according to a preset rule based on a distribution pattern of the nodes includes:
connecting adjacent nodes with an undirected edge.

Further, in the above gaze estimation method, a training process of the graph machine learning model includes:
collecting {eye data samples, gaze data samples} examples, where the eye data samples include eye data samples collected by an eye data collection device under multiple poses relative to a user's head;
extracting each gaze feature point from the eye data samples to obtain gaze feature point samples;
generating graph representation samples based on the gaze feature point samples, and establishing {graph representation samples, gaze data samples} examples based on the graph representation samples and corresponding gaze data samples; and
training the graph machine learning model using the {graph representation samples, gaze data samples} examples, where inputs of the graph machine learning model are the graph representation samples, and outputs are the gaze data.

Further, in the above gaze estimation method, the poses of the eye data collection device relative to the user's head include:
the eye data collection device being worn normally on the user's head;
the eye data collection device being shifted upward by a preset distance and/or rotated upward by a preset angle relative to the state of being worn normally on the user's head;
the eye data collection device being shifted downward by a preset distance and/or rotated downward by a preset angle relative to the state of being worn normally on the user's head;
the eye data collection device being shifted leftward by a preset distance and/or rotated leftward by a preset angle relative to the state of being worn normally on the user's head; and
the eye data collection device being shifted rightward by a preset distance and/or rotated rightward by a preset angle relative to the state of being worn normally on the user's head.

The present invention further discloses a gaze estimation apparatus, including:
a data acquisition module configured to acquire eye data and determine state and position information of multiple gaze feature points based on the eye data, where the gaze feature point is a point containing eyeball movement information and usable for calculating gaze data;
a graph model establishment module configured to, using each of the gaze feature points as a node, establish a relationship between the nodes to obtain a graph model;
a graph representation establishment module configured to determine feature information of the graph model based on the state and position information of each of the gaze feature points, and assign the feature information to the graph model to obtain a graph representation corresponding to the eye data; and
a gaze estimation module configured to input the graph representation into a graph machine learning model, perform gaze estimation through the graph machine learning model, and output gaze data, where the graph machine learning model has been pre-trained using a sample set, and the sample set includes multiple graph representation samples and corresponding gaze data samples.

The present invention further discloses a computer-readable storage medium, where a computer program is stored on the computer-readable storage medium, and when the program is executed by a processor, the gaze estimation method described in any one of the above embodiments is implemented.

The present invention further discloses an electronic device, including a memory, a processor, and a computer program stored on the memory and capable of running on the processor, where when the processor executes the computer program, the gaze estimation method described in any one of the above embodiments is implemented.

The present invention proposes a graph representation-based gaze estimation method. States and positions of gaze feature points are determined based on eye data, a graph representation is constructed based on the gaze feature points and the states and positions of the gaze feature points, and gaze data is calculated based on the graph representation of the gaze feature data using a pre-trained graph machine learning model. This method is highly robust, more accurate, and does not require a calibration process.

### BRIEF DESCRIPTION OF DRAWINGS

FIG. 1 is a flowchart of a gaze estimation method in Embodiment 1 of the present invention;

FIG. 2 is a schematic diagram of a pupil center point and six glint center points in an eye image;

FIG. 3 is a graph representation of gaze features in Embodiment 2;

FIG. 4 is a schematic diagram of a spatially distributed sparse photoelectric sensor apparatus;

FIG. 5 is a graph representation of gaze features in Embodiment 3;

FIG. 6 is a schematic structural diagram of a gaze estimation apparatus in Embodiment 4 of the present invention; and

FIG. 7 is a schematic structural diagram of an electronic device in an embodiment of the present invention.

### DETAILED DESCRIPTION

The embodiments of the present invention are described in detail below, and examples of the embodiments are illustrated in the accompanying drawings, where the same or similar reference numerals throughout denote the same or similar elements or elements having the same or similar functions. The embodiments described below with reference to the drawings are exemplary and are only used to explain the present invention, and should not be construed as limiting the present invention.

From the following description and drawings, these and other aspects of the embodiments of the present invention will become clear. In the description and drawings, specific implementations in the embodiments of the present invention are disclosed in detail to represent some ways of implementing the principles of the embodiments of the present invention, but it should be understood that the scope of the embodiments of the present invention is not limited thereto. On the contrary, the embodiments of the present invention include all changes, modifications, and equivalents falling within the spirit and scope of the appended claims.

### Embodiment 1

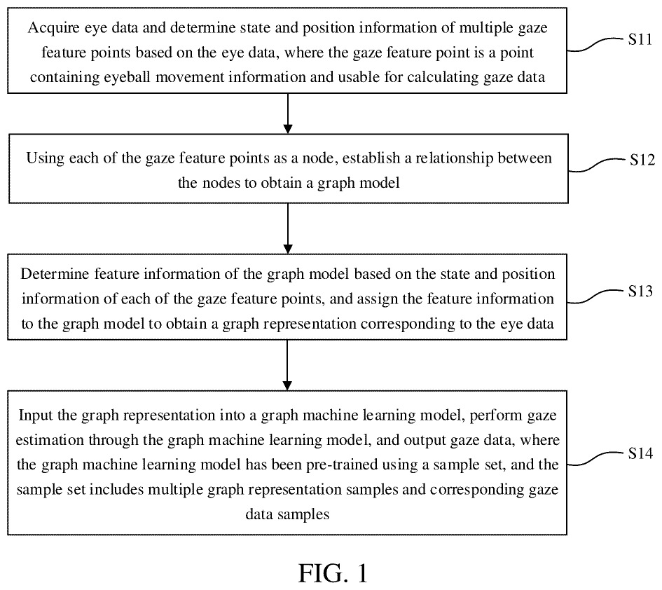

Referring to FIG. 1, a gaze estimation method in Embodiment 1 of the present invention includes steps S11 to S14.

Step S11: Acquire eye data and determine state and position information of multiple gaze feature points based on the eye data, where the gaze feature point is a point containing eyeball movement information and usable for calculating gaze data.

The eye data is an image of the human eye captured by a camera, which may be, for example, a single image captured by one camera, multiple images (sequential images) captured by a single camera, multiple images of a same object captured by multiple cameras, or positions and readings of spatially distributed sparse photoelectric sensors. The camera in this embodiment refers to any device capable of capturing and recording images, typically including components such as an imaging element, a dark chamber, an imaging medium, and an imaging control structure, with the imaging medium being CCD or CMOS. Spatially distributed photoelectric sparse sensors refer to photoelectric sensors that are sparsely distributed in space.

Based on the eye data, multiple gaze feature points and the state and position information of each feature point can be determined. If the eye data is an eye image captured by a camera, the multiple gaze feature points include at least two essential feature points, or at least one essential feature point and at least one non-essential feature point, where the essential feature point includes a pupil center point, a pupil ellipse focus, a pupil contour point, a feature on the iris, and an iris edge contour point, and the non-essential feature point includes a glint center point and an eyelid key point. If the eye data is eye data collected by a sensor apparatus (the sensor device including multiple spatially distributed sparse photoelectric sensors), the multiple gaze feature points are preset reference points of the photoelectric sensors.

Further, in other embodiments of the present invention, when the eye data is an eye image captured by a camera, the multiple gaze feature points may alternatively be multiple feature points determined by performing feature extraction on the eye image through a feature extraction network. The feature extraction network HS-ResNet first generates a feature map through traditional convolution, and the gaze feature points are the feature points in the feature map. The feature points in the feature map may be the essential feature points and non-essential feature points mentioned above, or points other than the essential feature points and non-essential feature points.

The state of a gaze feature point refers to an existence state of the gaze feature point, for example, whether it exists in an image, or whether it is successfully extracted by the feature extraction module, or a reading of the photoelectric sensor corresponding to the gaze feature point. The position of a gaze feature point refers to the two-dimensional coordinates of the gaze feature point in an image coordinate system or the three-dimensional coordinates in a physical coordinate system (such as any camera coordinate system or any photoelectric sensor coordinate system).

The multiple gaze feature points form a gaze feature point set. For a single image captured by a single camera, a data format of the gaze feature point set is {[x₀, y₀], [x₁, y₁], . . . , [xₘ, yₘ]}, where [xₘ, yₘ] is the coordinates of a gaze feature point numbered m in the image coordinate system.

For multiple images (sequential images) of a same object captured by a same camera or multiple images of a same object captured simultaneously by multiple cameras, a data format of the gaze feature point set is {[x₀₀, y₀₀], [x₀₁, y₀₁], . . . , [x₀ₙ, y₀ₙ]}, {[x₁₀, y₁₀], [x₁₁, y₁₁], . . . , [x₁ₙ, y₁ₙ]}, . . . , {[xₘ₀, yₘ₀], [xₘ₁, yₘ₁], . . . , [xₘₙ, yₘₙ]}, or {[x₀₀, y₀₀], [x₁₀, y₁₀], . . . , [xₘ₀, yₘ₀]}, {[x₀₁, y₀₁], [x₁₁, y₁₁], . . . , [xₘ₁, yₘ₁]}, . . . , {[x₀ₙ, y₀ₙ], [Xin, y₁ₙ], . . . , [xₘₙ, yₘₙ]}. Herein, m is a feature point number, n is an image number, and [xₘₙ, yₘₙ] represents the two-dimensional coordinates of a gaze feature point numbered m in a coordinate system of an image numbered n.

For multiple images (sequential images) of a same object captured by a same camera or multiple images of a same object captured simultaneously by multiple cameras, a data format of the gaze feature point set may be {[x₀, y₀, z₀], [x₁, y₁, z₁], . . . , [xₙ, yₙ, zₙ]}. Herein, [xₙ, yₙ, zₙ] is the three-dimensional coordinates of a feature point numbered n in a physical coordinate system (for example, any camera coordinate system).

It can be understood that the two-dimensional coordinates of gaze feature points in the image coordinate system of one or more images can be obtained through traditional image processing or deep learning-based neural network models; the three-dimensional coordinates of gaze feature points can be calculated based on their two-dimensional coordinates in multiple images through traditional multi-view geometry or deep learning-based neural network models, or directly calculated based on a single image or multiple images using deep learning-based neural network models.

If the eye data is eye data collected by a photoelectric sensor device, a data format of the gaze feature point set is {[x₀, y₀, z₀, s₀], [x₁, y₁, z₁, s₁], . . . , [xₙ, yₙ, zₙ, sₙ]}, where [xₙ, yₙ, zₙ, sₙ] represents the position and reading of a photoelectric sensor numbered n.

Step S12: Using each of the gaze feature points as a node, establish a relationship between the nodes to obtain a graph model.

In discrete mathematics, a graph is a structure used to represent a certain relationship between objects. A mathematically abstracted “object” is called a node or a vertex, and a relationship between nodes is called an edge. In the case of depicting a graph, nodes are typically represented by a set of points or small circles, and edges in the graph are represented by straight lines or curves, where the edges may be directed or undirected. Using each gaze feature point as a node, a relationship is established between the nodes to obtain a graph model. In the case of establishing a relationship between nodes, the nodes can be connected using edges according to a preset rule based on the distribution pattern of the nodes.

Step S13: Determine feature information of the graph model based on the state and position information of each of the gaze feature points, and assign the feature information to the graph model to obtain a graph representation corresponding to the eye data.

The feature information includes a node feature and/or an edge feature. The node feature includes: a state and/or a position of a gaze feature point corresponding to the node.

The edge feature includes: a distance and/or a vector between gaze feature points corresponding to two nodes connected by an edge.

Step S14: Input the graph representation into a graph machine learning model, perform gaze estimation through the graph machine learning model, and output gaze data, where the graph machine learning model has been pre-trained using a sample set, and the sample set includes multiple graph representation samples and corresponding gaze data samples.

The graph machine learning model has been pre-trained using a sample set. The sample set includes multiple graph representation samples and corresponding gaze data samples. The training steps for the graph machine learning model are as follows.
(a) Collect {eye data samples, gaze data samples} examples, where the eye data samples are image data or positions and readings of photoelectric sensors. The eye data samples include eye data samples collected by an eye data collection device under multiple poses relative to a user's head. The eye data samples are examples (descriptions of the corresponding information recorded by the camera or photoelectric sensors), and the gaze data are labels (information about the gaze results corresponding to the examples).

The poses of the eye data collection device relative to the user's head include:
the eye data collection device being worn normally on the user's head;
the eye data collection device being shifted upward by a preset distance and/or rotated upward by a preset angle relative to the state of being worn normally on the user's head;
the eye data collection device being shifted downward by a preset distance and/or rotated downward by a preset angle relative to the state of being worn normally on the user's head;
the eye data collection device being shifted leftward by a preset distance and/or rotated leftward by a preset angle relative to the state of being worn normally on the user's head; and
the eye data collection device being shifted rightward by a preset distance and/or rotated rightward by a preset angle relative to the state of being worn normally on the user's head.
(b) Create {gaze feature point set samples, gaze data samples} examples. Based on the {eye data samples, gaze data samples} examples, determine gaze feature points based on the eye data to obtain a gaze feature point set, which is then combined with corresponding gaze data samples to form {gaze feature point set samples, gaze data samples} examples.
(c) Create {graph representation samples, gaze data samples} examples. In accordance with the {gaze feature point set samples, gaze data samples}, based on the gaze feature point set samples and steps S12 and S13, obtain graph representation samples corresponding to the gaze feature point set samples, and combine the graph representation samples with corresponding gaze data samples to form {graph representation samples, gaze data samples} examples.
(d) Determine a structure of the graph machine learning model, where inputs of the model are graph representations, and outputs of the model are gaze data. The model structure consists of a multi-layer graph neural network, a fully connected network, and the like.
(e) Perform forward propagation calculation. From the {graph representation samples, gaze data samples} examples, take a batch of data to obtain a graph representation sample A and a gaze data label D. Input the graph representation sample A into the graph machine learning model, which is first processed by the multi-layer graph neural network to obtain a graph representation B, and then processed by the fully connected network to obtain model output gaze data C.
(f) Perform loss calculation between the forward propagation calculation result gaze data C and the gaze data label D to obtain a loss value L, where a loss function may be MAE or MSE.
(g) Based on the loss value L, update parameters of the graph machine learning model using gradient descent.
(h) Repeat steps e to g to iteratively update the parameters of the graph machine learning model to reduce the loss value L. End training when a preset training condition is met. The preset condition includes, but is not limited to: the loss value L having converged; a preset number of training iterations having been reached; and a preset training duration having been reached.

After the graph machine learning model is trained, the trained graph machine learning model can be used to perform gaze estimation on the graph representation obtained based on the current eye data.

The gaze estimation method in this embodiment can integrate data from multiple gaze features for gaze estimation, offering strong robustness and higher accuracy. This method does not require a calibration process, as the distribution patterns of the user's eye data are included in a dataset used for training the graph machine learning model. After the graph machine learning model is trained, users can use the gaze estimation function without calibration. Additionally, the dataset used for training the gaze estimation model also includes eye and gaze data collected under different relative poses between the gaze estimation apparatus and the user's head. As a result, this method is insensitive to changes in the relative pose between the gaze estimation apparatus and the user's head, offering greater operational flexibility for users and accurate gaze estimation.

### Embodiment 2

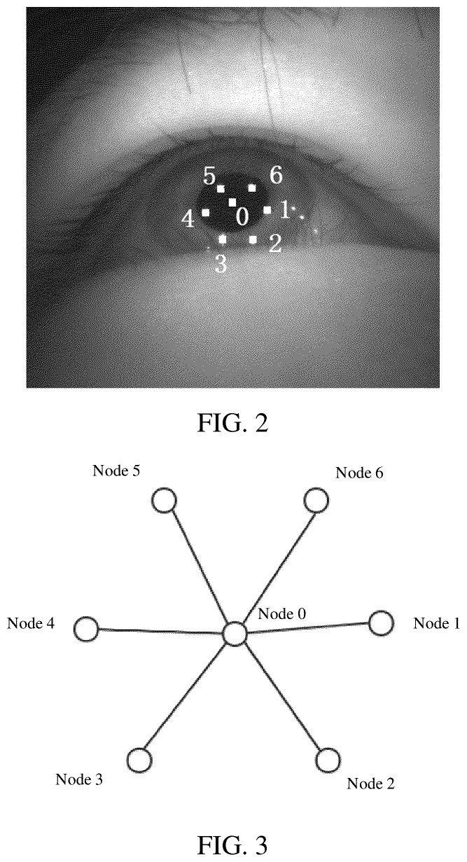

This embodiment takes eye data as image data captured by a camera as an example to illustrate a gaze estimation method of the present invention, including the following steps S21 to S24.
S21: Acquire eye data through a camera to obtain an eye image; then extract gaze feature points from the image to obtain a gaze feature point set {[x₀, y₀], [x₁, y₁], . . . , [x₆, y₆]}, where [xₘ, yₘ] is coordinates of a gaze feature point numbered m in an image coordinate system. In this example, a pupil center point and six glint center points are selected as gaze feature points, numbered 0 to 6, as shown in FIG. 2.
S22: Using each gaze feature point as a node, establish a relationship between the nodes to obtain a graph model, as shown in FIG. 3. The node corresponding to the pupil center point is connected to the nodes corresponding to the glint center point using undirected edges.
S23: Determine feature information of the graph model based on state and position information of the pupil center point and glint center points, and assign the feature information to the graph model to obtain a graph representation corresponding to the eye data. The feature information is normalized coordinates of the pupil center point and glint center points in the image coordinate system.
S24: Input the graph representation into a graph machine learning model, perform gaze estimation through the graph machine learning model, and output gaze data. The graph machine learning model has been pre-trained using a sample set, where the sample set includes multiple graph representation samples and corresponding gaze data samples. The training steps for the graph machine learning model are as follows.
(a) Collect {eye data samples, gaze data samples} examples, where the eye data samples are image data. Gaze data are examples (descriptions of the corresponding information recorded by the camera), and gaze data are labels (information about the gaze results corresponding to the examples). The user wears the gaze estimation apparatus multiple times to collect {eye data samples, gaze data samples} examples under different wearing conditions. The user wears the gaze estimation apparatus normally and collects data three times; shifts the normally worn gaze estimation apparatus upward by a certain distance or rotates it upward by a certain angle and collects data twice; shifts the normally worn gaze estimation apparatus downward by a certain distance or rotates it downward by a certain angle and collects data twice; shifts the normally worn gaze estimation apparatus leftward by a certain distance or rotates it leftward by a certain angle and collects data once; and shifts the normally worn gaze estimation apparatus rightward by a certain distance or rotates it rightward by a certain angle and collects data once.
(b) Create {gaze feature point set samples, gaze data samples} examples. Based on the {eye data samples, gaze data samples} examples, determine a gaze feature point set sample based on the eye data samples, which is then combined with corresponding gaze data to form {gaze feature point set samples, gaze data samples} examples.
(c) Create {graph representation samples, gaze data samples} examples. Based on the {gaze feature point set samples, gaze data samples} and steps S22 and S23, obtain graph representation samples corresponding to the gaze feature point set samples, and combine the graph representation samples with corresponding gaze data samples to form {graph representation samples, gaze data samples} examples.
(d) Determine a structure of the graph machine learning model, where inputs of the model are graph representations, and outputs of the model are gaze data.

The model structure consists of a multi-layer graph neural network, a fully connected network, and the like.
(e) Perform forward propagation calculation. From the {graph representation samples, gaze data samples} examples, take a batch of data to obtain a graph representation sample A and a gaze data label D. Input the graph representation sample A into the graph machine learning model, which is first processed by the multi-layer graph neural network to obtain a graph representation B, and then processed by the fully connected network to obtain model output gaze data C.
(f) Perform loss calculation between the forward propagation calculation result gaze data C and the gaze data label D to obtain a loss value L. A loss function may be MAE (mean absolute error) or MSE (mean squared error). The formula for MAE is:

$$loss ( x , y ) = \frac{1}{n} {\sum }_{i = 1}^{n} \vert {y}_{i} - f ( {x}_{i} ) \vert$$

The formula for MSE is:

$$loss ( x , y ) = \frac{1}{n} {\sum }_{i = 1}^{n} {( {y}_{i} - f ( {x}_{i} ) )}^{2}$$

where xᵢ is the graph representation (model input), f is the graph machine learning model, and yᵢ is the gaze data label.
(g) Based on the loss value L, update parameters of the graph machine learning model using gradient descent.
(h) Repeat steps e to g to iteratively update the parameters of the graph machine learning model to reduce the loss value L. End training when a preset training condition is met. The preset condition includes, but is not limited to: the loss value L having converged; a preset number of training iterations having been reached; and a preset training duration having been reached.

### Embodiment 3

This embodiment takes eye data as data collected by spatially discretely distributed photoelectric sensors as an example to illustrate a gaze estimation method of the present invention. The method steps are as follows.

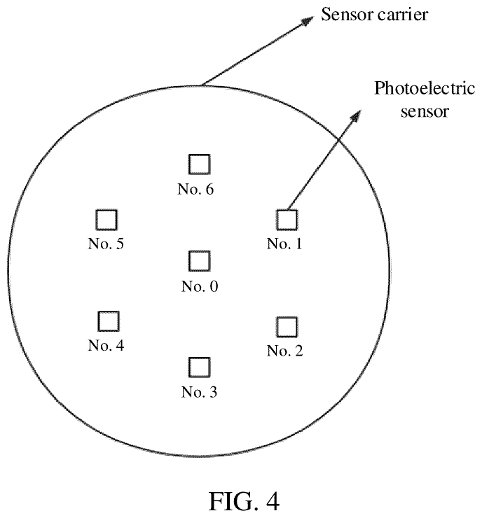

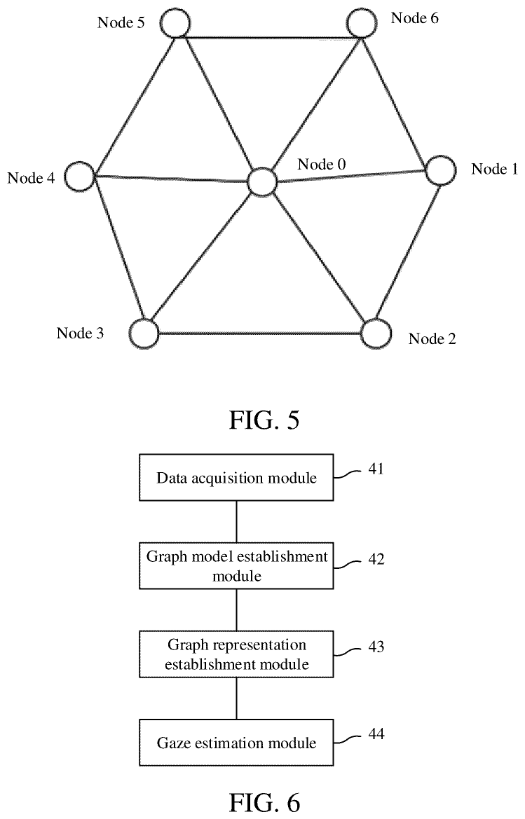

S31: Acquire eye data through photoelectric sensors. Use preset reference points of the photoelectric sensors as gaze feature points to obtain a gaze feature point set {[x₀, y₀, z₀, s₀], [x₁, y₁, z₁, s₁], . . . , [x₆, y₆, z₆, s₆]}, where [xₙ, yₙ, zₙ, sₙ] represents normalized coordinates and sensor readings of the photoelectric sensor numbered n in a physical coordinate system. In this example, each gaze feature point is numbered 0 to 6, as shown in FIG. 4.
S32: Using each gaze feature point as a node, establish a relationship between the nodes to obtain a graph model, as shown in FIG. 5. Nodes 1 to 6 are all connected to node 0 with edges, and adjacent nodes among nodes 1 to 6 are connected with undirected edges.
S33: Determine feature information of the graph model based on state and position information of the photoelectric sensors, and assign the feature information to the graph model to obtain a graph representation corresponding to the eye data.
S34: Input the graph representation into a graph machine learning model, perform gaze estimation through the graph machine learning model, and output gaze data. The graph machine learning model has been pre-trained using a sample set, where the sample set includes multiple graph representation samples and corresponding gaze data samples. The training steps for the graph machine learning model are as follows.
(a) Collect {eye data samples, gaze data samples} examples, where the eye data are positions and readings of the photoelectric sensors. The eye data samples are examples (descriptions of the corresponding information recorded by the photoelectric sensors), and the gaze data are labels (information about the gaze results corresponding to the examples). The user wears the gaze estimation apparatus multiple times to collect {eye data samples, gaze data samples} examples under different wearing conditions. The user wears the gaze estimation apparatus normally and collects data three times; shifts the normally worn gaze estimation apparatus upward by a certain distance or rotates it upward by a certain angle and collects data twice; shifts the normally worn gaze estimation apparatus downward by a certain distance or rotates it downward by a certain angle and collects data twice; shifts the normally worn gaze estimation apparatus leftward by a certain distance or rotates it leftward by a certain angle and collects data once; and shifts the normally worn gaze estimation apparatus rightward by a certain distance or rotates it rightward by a certain angle and collects data once.
(b) Create {gaze feature point set samples, gaze data samples} examples. Based on the {eye data samples, gaze data samples} examples, determine a gaze feature point set sample based on the eye data samples, which is then combined with corresponding gaze data samples to form {gaze feature point set samples, gaze data samples} examples.
(c) Create {graph representation samples, gaze data samples} examples. Based on the {gaze feature point set samples, gaze data samples} and steps S32 and S33, obtain graph representation samples corresponding to the gaze feature point set samples, and combine the graph representation samples with corresponding gaze data samples to form {graph representation samples, gaze data samples} examples.
(d) Determine a structure of the graph machine learning model, where inputs of the model are graph representations, and outputs of the model are gaze data. The model structure consists of a multi-layer graph neural network, a fully connected network, and the like.
(e) Perform forward propagation calculation. From the {graph representation samples, gaze data samples} examples, take a batch of data to obtain a graph representation sample A and a gaze data label D. Input the graph representation sample A into the graph machine learning model, which is first processed by the multi-layer graph neural network to obtain a graph representation B, and then processed by the fully connected network to obtain model output gaze data C.
(f) Perform loss calculation between the forward propagation calculation result gaze data C and the gaze data label D to obtain a loss value L. A loss function may be MAE (mean absolute error) or MSE (mean squared error). The formula for MAE is:

$$loss ( x , y ) = \frac{1}{n} {\sum }_{i = 1}^{n} \vert {y}_{i} - f ( {x}_{i} ) \vert$$

The formula for MSE is:

$$loss ( x , y ) = \frac{1}{n} {\sum }_{i = 1}^{n} {( {y}_{i} - f ( {x}_{i} ) )}^{2}$$

where xᵢ is the graph representation (model input), f is the graph machine learning model, and yᵢ is the gaze data label.
(g) Based on the loss value L, update parameters of the graph machine learning model using gradient descent.
(h) Repeat steps e to g to iteratively update the parameters of the graph machine learning model to reduce the loss value L. End training when a preset training condition is met. The preset condition includes, but is not limited to: the loss value L having converged; a preset number of training iterations having been reached; and a preset training duration having been reached.

### Embodiment 4

Referring to FIG. 6, a gaze estimation apparatus in Embodiment 4 of the present invention includes:
a data acquisition module 41 configured to acquire eye data and determine state and position information of multiple gaze feature points based on the eye data, where the gaze feature point is a point containing eyeball movement information and usable for calculating gaze data;
a graph model establishment module 42 configured to, using each of the gaze feature points as a node, establish a relationship between the nodes to obtain a graph model;
a graph representation establishment module 43 configured to determine feature information of the graph model based on the state and position information of each of the gaze feature points, and assign the feature information to the graph model to obtain a graph representation corresponding to the eye data; and
a gaze estimation module 44 configured to input the graph representation into a graph machine learning model, perform gaze estimation through the graph machine learning model, and output gaze data, where the graph machine learning model has been pre-trained using a sample set, and the sample set includes multiple graph representation samples and corresponding gaze data samples.

The implementation principles and technical effects of the gaze estimation apparatus provided in the embodiments of the present invention are the same as those of the aforementioned method embodiments. For brevity, for parts not mentioned in the apparatus embodiment, reference may be made to the corresponding content in the aforementioned method embodiments.

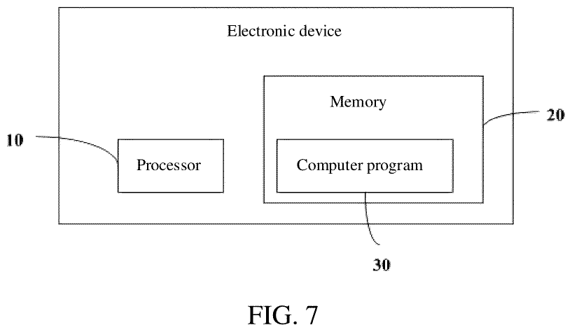

Another aspect of the present invention further proposes an electronic device. Referring to FIG. 7, the electronic device in the embodiment of the present invention includes a processor 10, a memory 20, and a computer program 30 stored on the memory and capable of running on the processor. When the processor 10 executes the computer program 30, the foregoing gaze estimation method is implemented.

The electronic device may be, but is not limited to, a gaze estimation apparatus, a wearable device, or the like. The processor 10, in some embodiments, may be a central processing unit (Central Processing Unit, CPU), a controller, a microcontroller, a microprocessor, or another data processing chip, used to run program code stored in the memory 20 or process data, and the like.

The memory 20 includes at least one type of readable storage medium. The readable storage medium includes a flash memory, a hard disk, a multimedia card, a card-type memory (for example, an SD or DX memory), a magnetic memory, a magnetic disk, a compact disc, and the like. In some embodiments, the memory 20 may be an internal storage unit of the electronic device, such as a hard disk of the electronic device. In some other embodiments, the memory 20 may be an external storage apparatus of the electronic device, such as a plug-in hard disk, a smart memory card, a secure digital card, or a flash card, equipped on the electronic device. Further, the memory 20 may include both an internal storage unit and an external storage apparatus of the electronic device. The memory 20 may be used not only to store application software and various types of data installed on the electronic device but also to temporarily store data that has been output or is to be output.

Optionally, the electronic device may further include a user interface, a network interface, a communication bus, and the like. The user interface may include a display, and an input unit such as a keyboard. Optionally, the user interface may further include standard wired interfaces and wireless interfaces. Optionally, in some embodiments, the display may be an LED display, a liquid crystal display, a touch-sensitive liquid crystal display, an OLED (Organic Light-Emitting Diode, organic light-emitting diode) touch device, or the like. The display, which may also be appropriately referred to as a display screen or display unit, is used to display information processed in the electronic device and used to display a visualized user interface. The network interface may optionally include a standard wired interface or a wireless interface (for example, a Wi-Fi interface), typically used to establish a communication connection between the apparatus and other electronic apparatuses. The communication bus is used to implement connection communication between these components.

It should be noted that the structure shown in FIG. 7 does not constitute a limitation on the electronic device. In other embodiments, the electronic device may include fewer or more components than shown, or combine certain components, or have a different arrangement of components.

The present invention further proposes a computer-readable storage medium, where a computer program is stored thereon, and when the program is executed by a processor, the foregoing gaze estimation method is implemented.

Those skilled in the art can understand that the logic and/or steps represented in the flowcharts or described in other ways herein, for example, can be considered as a sequenced list of executable instructions for implementing logical functions, which can be embodied in any computer-readable medium for use by an instruction execution system, apparatus (such as a computer-based system, a system including a processor, or other systems capable of fetching and executing instructions from an instruction execution system, apparatus), or in combination with such instruction execution systems, apparatuses. For the purposes of this specification, a “computer-readable medium” can be any device that can contain, store, communicate, propagate, or transport a program for use by an instruction execution system, apparatus, or in combination with such instruction execution system and apparatus.

More specific examples (a non-exhaustive list) of computer-readable media include the following: an electrical connection part (electronic apparatus) with one or more wirings, a portable computer disk cartridge (magnetic device), random access memory (RAM), read-only memory (ROM), erasable programmable read-only memory (EPROM or flash memory), fiber optic devices, and portable compact disc read-only memory (CDROM). Additionally, the computer-readable medium may even be paper or another suitable medium on which the program can be printed, as the program can be obtained electronically, for example, by optically scanning the paper or other medium, followed by editing, interpreting, or processing in other suitable ways if necessary, and then storing it in a computer memory.

It should be understood that the various parts of the present invention may be implemented in hardware, software, firmware, or a combination thereof. In the above embodiments, multiple steps or methods may be implemented in software or firmware stored in a memory and executed by a suitable instruction execution system. For example, if implemented in hardware, as in another embodiment, they may be implemented using any one or a combination of the following technologies known in the art: discrete logic circuits with logic gates for implementing logic functions on data signals, application-specific integrated circuits with suitable combinational logic gates, programmable gate arrays (PGA), field-programmable gate arrays (FPGA), and the like.

In the description of this specification, descriptions with reference to terms such as “one embodiment”, “some embodiments”, “example”, “specific example”, or “some examples” mean that the specific features, structures, materials, or characteristics described in connection with the embodiment or example are included in at least one embodiment or example of the present invention. In this specification, schematic representations of the above terms do not necessarily refer to the same embodiment or example. Moreover, the specific features, structures, materials, or characteristics described may be combined in any suitable manner in any one or more embodiments or examples.

The above embodiments only express several implementations of the present invention, and their descriptions are relatively specific and detailed, but they should not be understood as limiting the scope of the patent of the present invention. It should be noted that, for those skilled in the art, several variations and improvements can be made without departing from the concept of the present invention, and these all fall within the protection scope of the present invention. Therefore, the protection scope of the patent of the present invention shall be subject to the appended claims.

1. A gaze estimation method, comprising:
acquiring eye data and determining state and position information of multiple gaze feature points based on the eye data, wherein the gaze feature point is a point containing eyeball movement information and usable for calculating gaze data;
using each of the gaze feature points as a node and establishing a relationship between the nodes to obtain a graph model;
determining feature information of the graph model based on the state and position information of each of the gaze feature points, and assigning the feature information to the graph model to obtain a graph representation corresponding to the eye data; and
inputting the graph representation into a graph machine learning model, performing gaze estimation through the graph machine learning model, and outputting gaze data, wherein the graph machine learning model has been pre-trained using a sample set, and the sample set comprises multiple graph representation samples and corresponding gaze data samples.

2. The gaze estimation method according to claim 1, wherein the eye data is an eye image captured by a camera or data collected by a sensor device; wherein
when the eye data is an eye image captured by a camera, the multiple gaze feature points comprise at least two essential feature points, or at least one essential feature point and at least one non-essential feature point, wherein the essential feature point comprises a pupil center point, a pupil ellipse focus, a pupil contour point, a feature on the iris, and an iris edge contour point, and the non-essential feature point comprises a glint center point and an eyelid key point; and
when the eye data is data collected by a sensor device, the sensor device comprises multiple spatially distributed sparse photoelectric sensors, and the multiple gaze feature points are preset reference points of the photoelectric sensors.

3. The gaze estimation method according to claim 1, wherein the eye data is an eye image captured by a camera, and the multiple gaze feature points are multiple feature points determined by performing feature extraction on the eye image through a feature extraction network.

4. The gaze estimation method according to claim 1, wherein the feature information comprises a node feature and/or an edge feature, wherein the node feature comprises:
a state and/or a position of a gaze feature point corresponding to a node; and
the edge feature comprises:
a distance and/or a vector between gaze feature points corresponding to two nodes connected by an edge.

5. The gaze estimation method according to claim 1, wherein the establishing a relationship between the nodes comprises:
connecting the nodes with edges according to a preset rule based on a distribution pattern of the nodes.

6. The gaze estimation method according to claim 5, wherein the eye data is an eye image captured by a camera, the multiple gaze feature points comprise a pupil center point and multiple glint center points around the pupil center point, and the connecting the nodes with edges according to a preset rule based on a distribution pattern of the nodes comprises:
connecting a node corresponding to the pupil center point with nodes corresponding to the glint center points using undirected edges.

7. The gaze estimation method according to claim 5, wherein the eye data is an eye image captured by a camera, the multiple gaze feature points are feature points determined by performing feature extraction on the eye image through a feature extraction network, and the connecting the nodes with edges according to a preset rule based on a distribution pattern of the nodes comprises:
connecting adjacent feature points with an undirected edge.

8. The gaze estimation method according to claim 5, wherein the eye data is data collected by a sensor device, the sensor device comprises multiple spatially distributed sparse photoelectric sensors, the multiple gaze feature points are preset reference points of the photoelectric sensors, and the connecting the nodes with edges according to a preset rule based on a distribution pattern of the nodes comprises:
connecting adjacent nodes with an undirected edge.

9. The gaze estimation method according to claim 1, wherein a training process of the graph machine learning model comprises:
collecting {eye data samples, gaze data samples} examples, wherein the eye data samples comprise eye data samples collected by an eye data collection device under multiple poses relative to a user's head;
extracting each gaze feature point from the eye data samples to obtain gaze feature point samples;
generating graph representation samples based on the gaze feature point samples, and establishing {graph representation samples, gaze data samples} examples based on the graph representation samples and corresponding gaze data samples; and
training the graph machine learning model using the {graph representation samples, gaze data samples} examples, wherein inputs of the graph machine learning model are the graph representation samples, and outputs are the gaze data.

10. A gaze estimation apparatus, comprising:
a data acquisition module configured to acquire eye data and determine state and position information of multiple gaze feature points based on the eye data, wherein the gaze feature point is a point containing eyeball movement information and usable for calculating gaze data;
a graph model establishment module configured to, using each of the gaze feature points as a node, establish a relationship between the nodes to obtain a graph model;
a graph representation establishment module configured to determine feature information of the graph model based on the state and position information of each of the gaze feature points, and assign the feature information to the graph model to obtain a graph representation corresponding to the eye data; and
a gaze estimation module configured to input the graph representation into a graph machine learning model, perform gaze estimation through the graph machine learning model, and output gaze data, wherein the graph machine learning model has been pre-trained using a sample set, and the sample set comprises multiple graph representation samples and corresponding gaze data samples.

11. A computer-readable storage medium, wherein a computer program is stored on computer-readable storage medium, and when the program is executed by a processor, the gaze estimation method according to claim 1 is implemented.

12. An electronic device, comprising a memory, a processor, and a computer program stored on the memory and capable of running on the processor, wherein when the processor executes the computer program, the gaze estimation method according to claim 1 is implemented.
